(19) United States
(12) Patent Application Publication
(10) Pub. No.: US 2002/0083077 A1
(43) Pub. Date: Jun. 27, 2002

(54) Aggregation and dissemination of hardware and software inventory data

(75) Inventor: David Vardi, New York, NY (US)

Correspondence Address: OSTROLENK FABER GERB & SOFFEN, 1180 AVENUE OF THE AMERICAS, NEW YORK, NY, 100368403

(73) Assignee: Isogon Corporation

(21) Appl. No.: 10/026,309

(22) Filed: Dec. 22, 2001

Related U.S. Application Data
(60) Provisional application No. 60/257,335, filed on Dec. 21, 2000.

(51) Int. Cl. G06F 7/00

(52) U.S. Cl. 707/102

(57) ABSTRACT

A system and method that automates the task of collecting information from different locations on the Internet and converts it from a variety of downloaded formats to standardized or consolidated formats for easier presentation and understanding. The invention includes a Raw Information Retriever, which communicates with various data providers via the Internet or other types of data lines. The raw information is supplied to a data collector which standardizes, consolidates or correlates information gathered from different sources and supplies it to an analyzer and report generator that provides the information to a user in a format that is easier to use or analyze the significance of gathered data.

### BACKGROUND OF THE INVENTION

This Application claims priority and is entitled to the filing date of U.S. Provisional Application Serial No. 60/257,335 filed Dec. 21, 2000, and entitled “AGGREGATION AND DISSEMINATION OF HARDWARE AND SOFTWARE INVENTORY DATA,” the contents of the provisional patent application are incorporated by reference herein.

The present invention relates to a software system and method for data gathering and presentation and, more particularly, to a software system and method which automates a process that collects information from a variety of websites concerning specific subject matter and aggregates and collates the information for better presentation to users.

Many financial institutions have established on-line access to databases where their customers can view information regarding their bank accounts, credit cards, retirement plans, brokerage accounts, etc. Internet Service Providers, Search Engines and Web Portals provide e-mail accounts using ordinary web browsers.

Typically, such access is provided via Internet web sites which registered users logon and can then view their personalized data. These different web sites provide the information in different presentations which require different methods and user interfaces to access the information.

Some browsers such as Opera permit users to simultaneously display multiple web pages in individual windows tiled to fit the display screen. Each window is independent of the others, hence, there is no coordination of login procedures, data access, aggregation of data, etc.

Some financial management programs, such as Quicken from Intuit, permit users to conduct online transactions (using proprietary protocols) with participating financial institutions such as downloading financial statements, pay bills, obtain stock quotes, etc.

Other services such as MyCiti from Citibank (www.myciti.com) and ezlogin from Ezlogin.com (www.ezlogin.com) use “screen scraping” techniques and customized applications to aggregate information from user supplied web accounts and present that information to the user in a single window typically categorized according to type of account—e-mail, banking, credit cards, frequent flyer accounts, etc. In return for providing confidential account and login information, the user need only login to a single service, typically in a single display window, to obtain an aggregated view of all of his accounts and perform a normal range of services for each account as though he had directly logged in.

The applications that perform the aggregation of data deal with well-known entities and common denominators—universally common to almost all individuals and many organizations. A bank account holds money; a brokerage holds stocks and bonds; frequent flyer accounts accumulate miles; e-mail accounts send and receive messages, and news clipping services clip and serve up news items. Further, other than to act as a “one-stop” portal to the user's accounts, these applications do not generally attempt to consolidate the information or provide the user with other options and capabilities even though the potential is there to refine the data in ways that might be meaningful to the user. For example, a user having purchased the same stock from different brokerages is not easily able to automatically determine how many shares are owned nor can he readily obtain summaries of what credit card purchases have been made to specific vendors.

Less common, but nonetheless a real concern for many private individuals and organizations, is the problem of tracking their inventory of software and hardware, acquired through purchase, lease, license, etc. For example, a small business can easily accumulate dozens or even hundreds of computers each containing numerous peripherals and software products from numerous manufacturers and resellers. While some would find a “one-stop” portal for tracking this type of assets by reseller useful, these users typically require that their inventory data be consolidated and organized in a more meaningful manner.

Some manufacturers of hardware and software and some resellers have established on-line access to databases where customers can view information regarding their purchases—past, present, and proposed. Here too, such access is provided via Internet web sites which their customers logon and can then view their personalized data.

Users may deal with five or ten such resellers, each one potentially providing web-based information. These different web sites provide the information in different presentations which require different methods and user interfaces to access the information. However, aggregating such inventory data by source (i.e., vendor or reseller) is by itself meaningful, it would be more so if the user is able to aggregate and consolidate it into more meaningful categories such as hardware type, vendor, computer location, licensing and purchase terms, etc.

Even when information is downloadable from these web sites, users need to collect the information from different locations, convert it from a variety of download formats and then process it in order to present the information according to their needs.

### SUMMARY OF THE INVENTION

It is an object of the present invention to facilitate and automate the task of collecting information from different locations and converting it from a variety of download formats for easier presentation and understanding.

It is a further object of the present invention to correlate this information with local data and to detect changes thereof, optionally, automatically self-directing feedback to locations when errors and omissions have been detected.

The foregoing and other objects of the invention are realized by a data collector (DC) which is a software program that automatically collects information from different websites and by an analysis and consolidation software program which analyzes the data and consolidates and aggregates it in accordance with pre-determined rules to attain more comprehensive and easier to use presentation of information to users.

Other features and advantages of the present invention will become apparent from the following description of the invention which refers to the accompanying drawings.

### BRIEF DESCRIPTION OF THE DRAWINGS

FIG. 1 is a sample, conventional data layout that is obtainable from websites.

FIG. 2 illustrates a conventional data aggregation methodology.

FIG. 3 is an example of a novel data consolidation methodology in accordance with the present invention.

FIG. 4 is a second embodiment of FIG. 3.

FIG. 5 is a block diagram of the overall system of the present invention.

### DETAILED DESCRIPTION OF THE PRESENT INVENTION

The term “purchase” is meant to connote the granting of ownership or use rights via any of the following means: outright purchase, lease, rental, license and use rights.

The present invention consists of a software program for collecting software and hardware purchase (SHP) information, also referred to herein as the RIR (Raw Information Retriever), a database for storing this and processed data, and a program for aggregating and consolidating this information and presenting it to the user.

The data collector (DC) is a software program that automatically collects SHP information from the different web sites provided by the hardware and software sellers or resellers. The program is set up by the user to access each of the different sites, login to the user's accounts, and extract from these sites information that the user would otherwise have to access by himself. Access to specific sites might require the use of Internet protocols such as http or ftp, or dialing information and access commands for dial-in sites. Some sites may automatically deliver such information in the form of an e-mail message.

Optionally, the user may specify sites to access for comparison purposes. For example, a user may want to perform a price comparison among several vendors for specific items.

The information retrieval may require navigation through the site, submission of a query, or the outright downloading of the information. In some situations, a reseller may make available the invoices and purchase orders in data files suitable for electronic document interchange (EDI) that contain specific details of past and present purchases. The actual interchange may take place by downloading the EDI files or be transmitted to the user as part of an electronic mail message. The SHP data generated and made available by a particular seller or reseller may be extracted by the DC using any of the following means:

The relevant data is “screen scraped” from the Web-based data that is normally made available to a browser

Relevant data is “screen scraped” from the Web-based data that is displayed or generated by a software applet that has been made available to a browser

Downloading the data in XML markup form, if supplied by the web site

Downloading the data from files exported by the web site

Downloading the data from e-mail files sent by or requested from the web site

Running an application, such as a servlet uploadable to the web site, to gather user specified data and download it using any of the methods above.

In some cases, “screen scraping” may involve drilling down through various hyperlinks to obtain all of the detail data. In other instances, the web site provides an option to download this data. While the user can provide login and navigation details, which can be burdensome, the DC optionally provides a learning mode of operation whereby it records all of the steps of logging in and accessing the data for a particular website.

The DC stores the information in a database for subsequent processing after all of the designated sites and data have been retrieved. Each data record may contain information such as

Part Number, SKU, or other identifying information

Description

Vendor or Reseller—the operator of the website

Manufacturer

Item Type—hardware, software, etc.

Quantity

Cost

Purchase date (past or proposed)

Purchase terms and conditions

Serial number

Computer Location—Physical location, department, shipping address, etc.

Accounting information—Billing address, contracting officer, etc.

Additional site specific information that the DC may store in the database includes the date and time of the last visit, user account information, method for extracting data, etc. In the situation wherein the accounts represent the purchasing of an organization, the DC may also retain the names and passwords of those users authorized to access these sites.

The DC may be directed to perform this process on a regular on-going basis, perhaps weekly, or on an ad hoc basis. If a web site provides the capability of obtaining such information according to a user specified period of time, the DC by default uses the dates spanning the last visit to the present. The DC may be triggered by another program or the presence of files or some other alert.

Further processing of the information includes the ability to:

Resolve any ambiguities, mis-identification of a data item, determine the correct product designations, manufacturer names, model numbers, etc. when such information is either missing or incorrectly reported by a vendor's web site by correlating aggregated information against a knowledge base of hardware and software product information. For example, a site might use abbreviations in a product name, its own part numbers for a product it is reselling, or report the manufacturer's name in the product description.

Further consolidate the information from the different sources by identifying or providing common denominators such as a manufacturer name for a hardware product, version number for a software product, etc.

Maintain historical records. Detect when data has changed over time and update the database accordingly. Optionally, build up a picture of inventory-over-time.

Maintain a watch on user-specified items for data values that meet some criteria. Upon detection of these conditions the present invention may take an action set by the user such as to issue an email notification or other alert to the user. For example, total PCs exceeding some preset number, or ratio to something else. Or, if cost data is available, a price disparity from one vendor to another that exceeds a preset amount or percentage. Note that the criteria may or may not relate to some other data originated from the same site, a different site, or collected via other means.

If, as a result of the processing, it is determined that there are errors and omissions on the vendor's web site that bear correction, the DC may direct that a notification be directed to all affected web sites. The notification may take the form of an e-mail message, facsimile transmission, completing an on-line “form” provided by the vendor's web site, uploading a data file containing the corrections for verification by the vendor, or other facility of message transfer that may be provided by a vendor for that purpose. Additional processing of the data is performed to

Create data files which represent a consolidation of the data, or user-specified subsets of the data, collected from the different sites. These data files can be used by other applications such as spreadsheets and other asset management software for further analysis or to populate and update other databases.

Correlate consolidated information with physical inventory data, or inventories generated by other software tools such as SMS, Tally TS.Census, Manhasset or SoftAudit.

Correlate consolidated information with contractual data in a contracts repository such as Argis or Galaxy Vista.

In a further extension of the current embodiment, the present invention processes the data for presentation and display to the user. The data can be organized in numerous ways that are meaningful to the user such as

Hardware and/or Software by supplier and/or manufacturer. For example, Microsoft software from reseller A, PC supplier B, store C, and mail order.

Hardware and software aggregated by purchasing authority within the organization.

Hardware and software aggregated by shipping location or destination.

Comparison of prices, by supplier, for similar items.

Creation of pricing trends by item, optionally by supplier.

For software licensed to identified entities (such as a particular CPU, or a particular site, or department), licensed software by entity.

For all the above, display acquisitions and current inventory over a specific period of time (e.g. monthly for a 3 year period).

In addition to presenting it to the user, this data may be disseminated as data files, in the appropriate formats, for use by other programs.

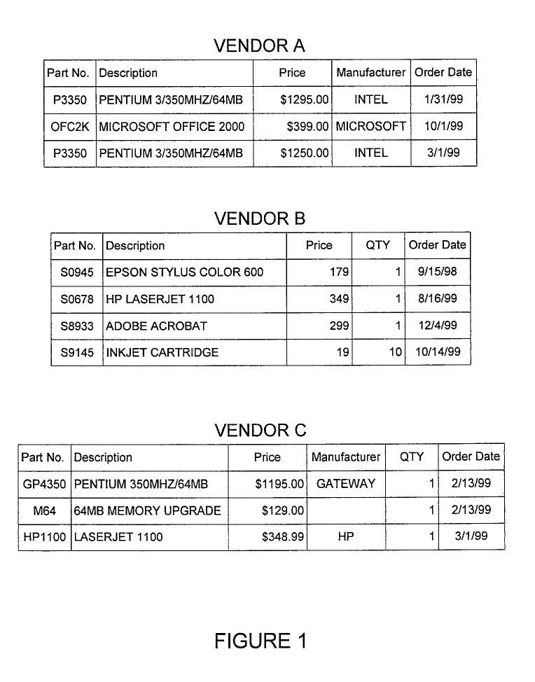

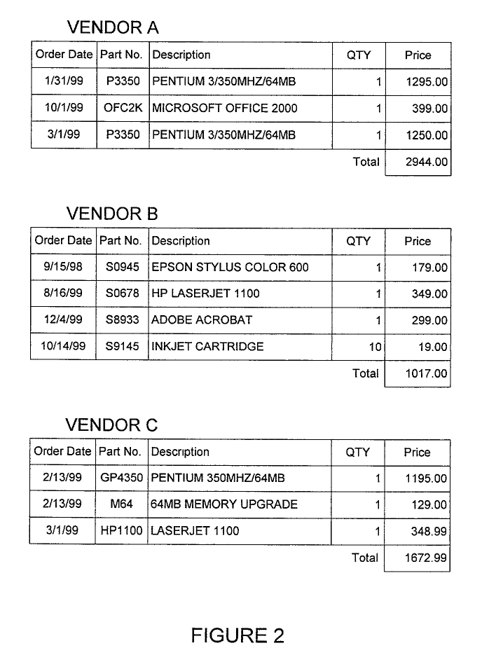

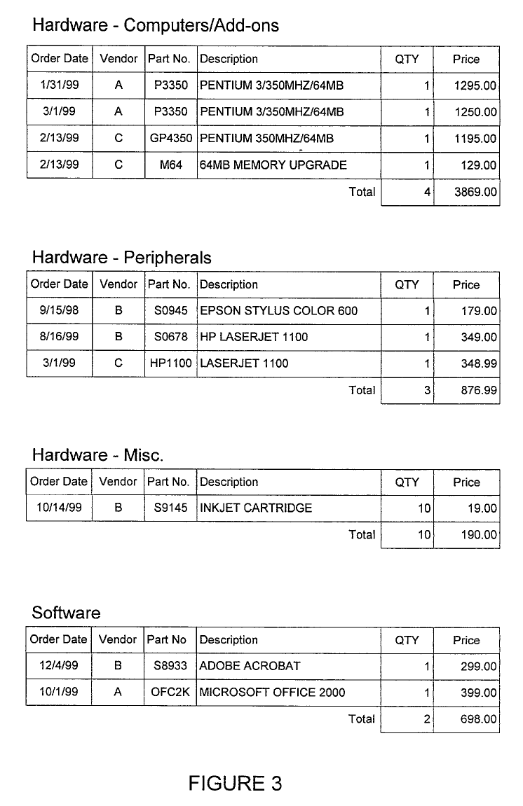

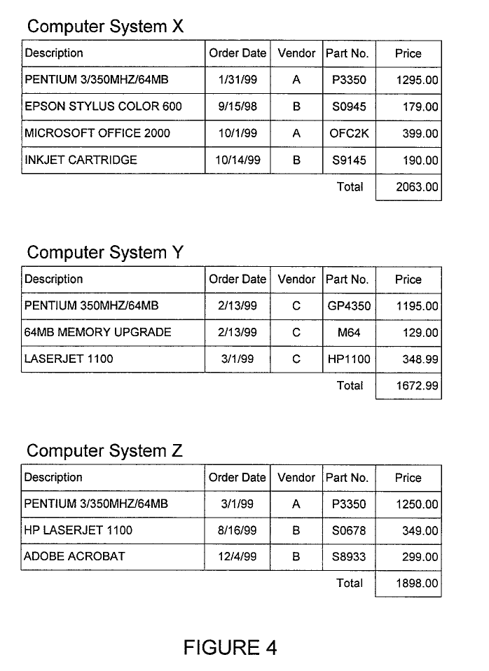

FIG. 1 is a sample of an organization's purchasing information as provided by the web sites of three vendors. Each site provides the same characteristic data such as part number, description, and price, while some vendors may also provide additional details such as the manufacturer. Using conventional data aggregation methodology, the information might be presented according to vendor (FIG. 2). However, the present invention consolidates this information for the user and presents it in a more meaningful manner. For example, FIG. 3 demonstrates how the data is consolidated by type hardware according to hardware type and uncategorized software. FIG. 4 demonstrates the same data organized by location—in this example, the components comprising each computer system.

As described herein, the DC may be a program operative upon the user's computer or as a process running on a remote computer system or web site. In the latter instance, the SHP information is automatically obtained for the user and reported to him when he logs in or otherwise accesses the remote site.

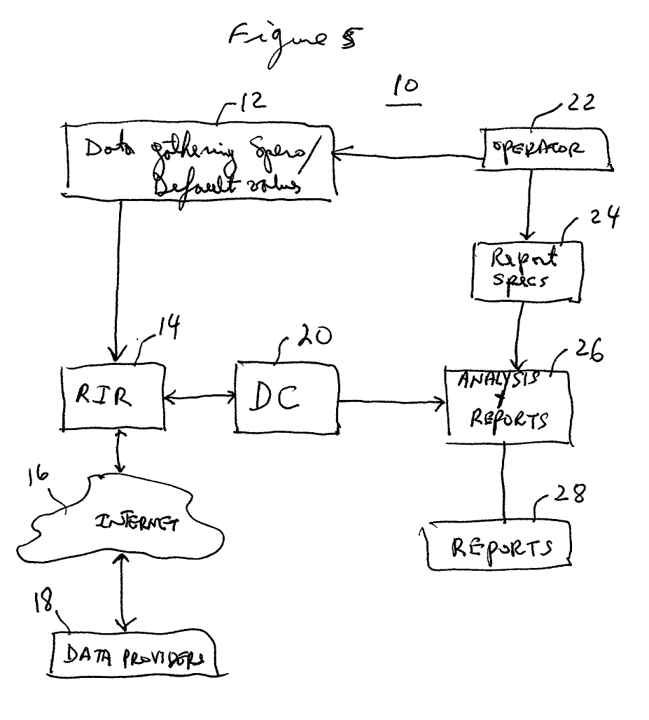

With reference to FIG. 5, the overall system and method 10 of the present invention comprises a data gathering specification block 12 which also acts as a repository for default values for the type of information that is to be gathered. The information in the data gathering specification block 12 can be predefined or periodically or occasionally defined by an operator 22. It may also contain default values for carrying out the proper search for information. The actual retrieval of raw information is carried out by an RIR 14 (Raw Information Retriever) which communicates via the Internet 16 with a plurality of data providers 18 which may be the web sites of various product or service providers. Alternatively or additionally, the information may be obtained by communicating over local area networks or wide area networks, over public or private data lines (not shown).

The information gathered by the RIR 14 is processed by the data collector 20 which supplies the information in standardized or consolidated formats to the analysis and reports block 26. The analysis and reports block 26 prepares the reports 28 for use by the operator 22 or by automated software or systems. Specifications on how the reports should be gathered and what information should be gathered or how information should be consolidated or organized or presented, can be provided within the analysis and reports block 26 or can be specified by a reports specification block 24 as shown.

In another embodiment, the present invention aggregates and consolidates information regarding the financial assets of multiple individuals and organizations, hereinafter, owners.

The DC is augmented to provide support for multiple users (i.e., owners) accessing and storing the asset information in a database indexed by owner for subsequent processing after all of the designated sites and data have been retrieved. Each data record may contain information such as

Asset code, stock symbol, or other identifying information

Description

Account—the operator of the website providing financial services (i.e., bank, brokerage, etc.)

Asset Type—cash, stock, bond, mutual fund, etc.

Quantity

Cost

Purchase date (past or proposed)

Serial number, if applicable

Owner

Other facilities of the current invention are suitably augmented to consolidate, display and report on these types of financial information.

For example, a family consisting of two parents and minor children may collectively own multiple accounts for checking and savings, brokerages, IRAs, mutual funds, 401-k retirements accounts, etc. some of which are jointly owned and others individually. Among these accounts, investments in the same stocks, bonds and mutual funds may have been made for the same owner or multiple owners—typically at different times and subject to the then current market rate.

It is generally incumbent upon a single individual (parent, financial advisor, etc.) to manage such accounts. Thus the present invention provides the manager of such assets a tool to consolidate and analyze this information in the following meaningful ways:

Asset by account. For example, Microsoft stock from brokerage A, brokerage B, IRA, and 401-k.

Asset by owner. For example, Microsoft stock from owner X, owner Y, and owner Z.

Comparison of share prices and values, by owner, for similar items. For example, compare the performance of similar mutual funds, IRA or 401k accounts.

Creation of pricing trends by asset, optionally by owner.

For all the above, display acquisitions and current assets over a specific period of time (e.g. monthly for a 3 year period).

It should be noted that while the example presented is for family members, the present embodiment is equally applicable for the situation wherein a financial advisor is providing management services to a group of independent investors.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

1. A system for collection and consolidation of information gathered from a plurality of remotely located data providers, the system comprising:
a data gathering specification database that specifies the locations of data providers from which data is to be gathered and the data that is to be gathered;
an information retriever software coupled to the data gathering specification database and effective for establishing communication with the data providers and for retrieving from the data providers the data to be gathered;
a data collector coupled to the information retriever, the data collector including a facility for segregating data records retrieved by the information retriever into data records types and for correlating and consolidating data records received from different data providers according to the data record types;
an analyzer and report generator coupled to the data collector for categorizing information according to desired report formats and for creating report records; and
a report generator for creating and providing consolidated reports of data obtained from the data providers.

2. The system of claim 1, in which the data providers are remotely located web sites of product and/or service vendors.

3. The system of claim 1, in which the data providers have databases accessible via local area networks or wide area networks.

4. The system of claim 1, in which the information retrieved by the information retriever comprises hardware and software inventory data.

5. The system of claim 1, in which the information retriever is capable of operating fully automatically in gathering data, including accessing web sites without manual operator intervention.

6. The system of claim 1, in which the data collector includes a facility that detects changes in data records over time.

7. The system of claim 1, including a facility that gathers data for comparison of purposes, involving the gathering of data from websites which contain information that is not personal to a requester of the information.

8. The system of claim 1, in which the information retriever retrieves data records by a screen scraping process.

9. The system of claim 1, in which the information retriever retrieves data by the use of software applets made available to a browser facility thereof.

10. The system of claim 1, in which the information retriever retrieves data by downloading the data in XML mark-up form from various web sites.

11. The system of claim 1, in which the information retriever retrieves data that is exported by web sites.

12. The system of claim 1, in which the information retriever includes a learning mode facility that records the steps of logging in and accessing data from various web sites.

13. The system of claim 1, in which the data collector stores information in a database in data records that contain three or more of: part number; SKU; product description; vendor; manufacturer; item type; quantity; cost; purchase date; purchase terms and conditions; serial number; computer location; accounting information; contacting person; date and time of last visit; user account information; and method for extracting data.

14. The system of claim 1, in which the system includes a facility that enables specification whether information is to be retrieved periodically, or at user specified times, or continuously.

15. The system of claim 1, in which the data collector includes a facility for resolving ambiguities and inconsistencies in data retrieved by the information retriever.

16. The system of claim 1, including a facility for providing common denominators for data selection.

17. The system of claim 1, including a facility that retrieves and maintains historical data records.

18. The system of claim 1, including a facility that enables a user to set parameters for watching and reporting user specified data items.

19. The system of claim 1, including a facility that reports to the data providers errors or omissions in their data.

20. The system of claim 1, in which the analyzer and report generator has a facility that prepares reports that are compatible with and transportable to spreadsheet databases.

21. The system of claim 1, including a correlator that is effective for consolidating data with physical inventory data obtained by other systems.

22. The system of claim 1, in which the report generator includes a facility that enables the preparation of presentation data.

23. The system of claim 1, in which the data records for the data providers comprise financial assets of a plurality of individuals.

24. The system of claim 23, in which the financial data records comprise two or more of: asset code; stock symbol; description; account identification; asset type; quantity; cost; purchase date; serial number; and owner.
